(19) United States
(12) Patent Application Publication
(10) Pub. No.: US 2025/0129199 A1
(43) Pub. Date: Apr. 24, 2025

(54) DEGRADABLE POLYMER COMPOSITION AND METHODS OF MANUFACTURING AND USING IN DOWNHOLE TOOLS

(71) Applicants: CNPC USA CORPORATION, Houston, TX (US); BEIJING HUAMEI, INC., Beijing (CN)

(72) Inventors: Jiaxiang REN, Katy, TX (US); Peng CHENG, Houston, TX (US)

(21) Appl. No.: 19/002,591

(22) Filed: Dec. 26, 2024

Related U.S. Application Data
(63) Continuation-in-part of application No. 17/239,680, filed on Apr. 25, 2021.

(51) Int. Cl. C08G 18/10; E21B 33/12

(52) U.S. Cl. CPC C08G 18/10; C08G 2230/00; E21B 33/1208; E21B 2200/08

(57) ABSTRACT

A chemical composition for a degradable polymeric material includes an isocyanate terminated polyester, polycarbonate, or polyether prepolymer, including prepolymer units as a main chain with a plurality of isocyanates at ends of the main chain, a catalyst additive, and a cross-linking agent. The composition degrades at a rate and at a delay depending on temperature. The composition is a dissolvable rubber material with a modulus and elongation suitable for a component of a downhole tool.

### CROSS-REFERENCE TO RELATED APPLICATIONS

The present application claims the benefit of, and is a continuation-in-part of, U.S. Non-Provisional patent application Ser. No. 17/239,680, filed Apr. 25, 2021, entitled DEGRADABLE POLYMER COMPOSITION AND METHODS OF MANUFACTURING AND USING IN DOWNHOLE TOOLS, which is hereby incorporated by reference as if fully set forth herein in their entirety.

### BACKGROUND OF THE INVENTION

### 1. Field of the Invention

The present invention relates to a material composition in the oil and gas industry. More particularly, the present invention relates to degradable polymer compositions to form components of downhole tools. Even more particularly, the present invention relates to a water dissolvable elastomer with modulus and elongation suitable for sealing components of downhole tools.

### 2. Description of Related Art Including Information Disclosed Under 37 CFR 1.97 and 37 CFR 1.98

A plug is a downhole tool used in oil and gas operations. Non-conventional oil and gas production has replaced millable composite plugs with dissolvable plugs in downhole operations, like fracturing operations. After the fracturing, the dissolvable plug is dissolved in the downhole fluids. Milling to remove a milling composite plug is no longer required. Therefore, the operation time and costs of milling were saved. A dissolvable elastomer or degradable polymer is an essential component of each dissolvable plug because a dissolvable plug still requires sealing. Even the material for sealing must be degradable along with the other hard components of the dissolvable plug. A degradable polymer is used as a sealing material needed for dissolvable plugs.

The degradable polymer or dissolvable elastomer still must be capable of sealing other materials. Maintaining sufficient elasticity for certain time period, such as more than 12 hours to complete a fracturing operation, is a necessary feature of a degradable polymer for a dissolvable downhole tool, such as a dissolvable plug. Additionally, the degradable polymer or dissolvable elastomer must be capable of degrading or dissolving as fast as possible in the downhole fluid after performing the fracturing operation.

The disclosure of degradable polymers or dissolvable elastomers or dissolvable rubbers are known in the prior art intended for a variety of conditions. US Publication No. 20170152371 published on 1 Jun. 2017 for Duan et al, U.S. Pat. No. 9,790,763 (the '763 patent), issued on 17 Oct. 2017 to Fripp et al, and US Publication No. 20170158942, published on 8 Jun. 2017 for Okura et al. disclose degradable polymers.

The '763 patent discloses a method to manufacture high strength degradable rubber with controlled dissolution rates. The degradable rubber is a polyester-polyurethane copolymer and copolymer was crosslinked with selective cross-linkers. The dissolution rate was accelerated by mixing with selective catalysts. The dissolution rate of the degradable rubber is faster than the typical degradable rubbers in the market.

This invention discloses an improved high modulus and high elongation water degradable polymer material and its application in downhole oil tools. The high modulus and high elongation water degradable polymer material displayed faster dissolution rates than the dissolvable polymers in the market. There is a need for a higher modulus and higher elongation than possible with the traditional elastomers and other dissolvable elastomers in the market. The degradable polymer could be used as sealing materials for many downhole tools, including but not limited to fracture plugs, bridge plugs, packers, isolation valves, etc.

It is an object of the present invention to provide a degradable polymeric material.

It is another object of the present invention to provide a degradable polymeric material for components of a downhole tool.

It is still another object of the present invention to provide a degradable polymeric material with modulus and elongation for components of a downhole tool.

It is still another object of the present invention to provide a degradable polymeric material with dissolvability to control in downhole operations.

It is another object of the present invention to provide a degradable polymeric material with dissolvability compatible for fluids with different salinities.

It is an object of the present invention to provide a method of forming a degradable polymeric material for components of a downhole tool.

It is an object of the present invention to provide a method of using a degradable polymeric material in a component of a downhole tool.

These and other objectives and advantages of the present invention will become apparent from a reading of the attached specification.

### BRIEF SUMMARY OF THE INVENTION

Embodiments of the chemical composition for a degradable polymeric material of the present invention include an isocyanate terminated polyester, polycarbonate, or polyether prepolymer, a catalyst additive, and a cross-linking agent. The isocyanate terminated prepolymer includes prepolymer units as a main chain with a plurality of isocyanates at ends of the main chain with a cross-linking agent so as to be able to form a material suitable for components of a downhole tool. The composition dissolves or degrades at a controlled rate so as to maintain integrity for a downhole operation. The composition can also dissolve or degrade quickly after the downhole operation is completed. The composition has a high modulus and high elongation to hold high pressure differentials of a sealing component of a downhole tool during downhole operations, while remaining dissolvable.

Embodiments of the present invention also include the method of forming the degradable polymeric material. The method includes vacuuming the isocyanate terminated polyester, polycarbonate, or polyether prepolymer, vacuuming the cross-linking agent, mixing the isocyanate terminated prepolymer, the catalyst additive, and the cross-linking agent so as to form a mixture, and molding the mixture so as to form a cured polymer as a component. The step of mixing can be by centrifuge and can be under vacuum. The step of molding can include cast molding, rotational molding, or compression molding. Alternate embodiments include adding a filler during the step of mixing.

The method of using the degradable polymeric material is another embodiment of the present invention, in particular, removal of a downhole tool after a fracturing operation. The method for removal can include forming the chemical composition of the degradable polymeric material into a component, installing the component in an assembly, such as a downhole tool, dissolving the component in aqueous solution into a degraded small particles, and collapsing the assembly so as to remove the assembly and the degraded component.

Further in another embodiment, a degradable polymeric composite comprises a reaction product of an isocyanate, polyol, a degrading catalyst comprising at least a group consisting of a metal oxide and a base additive; and a cross-linking agent so as to reach fracture between 8 hours and 3 days, display more than 60% weight change within 10 days, depending on temperature, and the degradable polymeric composite sealing components maintain over 8000 psi pressure differential.

Optionally in any embodiment, isocyanate may be selected from a group consisting of: 2, 4-toluene di-isocyanate, 2, 6 toluene di-isocyanate, methylene diphenyl diisocyanate (MDI), para-phenyl diisocyanate (pPDI), and hexamethylene isocyanate (HDI).

Optionally in any embodiment, the metal oxide may be selected from a group consisting of: sodium oxide, potassium oxide, calcium oxide, and magnesium oxide.

Optionally in any embodiment, the base additive may be at least one of a metal hydroxide or a Lewis base.

Optionally in any embodiment, the metal hydroxide is selected from a group consisting of: sodium hydroxide, potassium hydroxide, calcium hydroxide, and magnesium hydroxide.

Optionally in any embodiment, the cross-linking agent is at least one of diamines, diols, or triols.

Further in yet another embodiment, a process for forming a degradable polymer composition comprises steps of admixing an isocyanate and a polyol to form a mixture; adding a degrading catalyst to the mixture; and mixing a cross-linking agent so as to reach fracture between 8 hours and 3 days, display more than 60% weight change within 10 days, depending on temperature, and the degradable polymeric composite sealing components maintain over 8000 psi pressure differential.

Yet further in another embodiment, a degradable polymer composite comprises a reaction product of an isocyanate terminated polyester, polycarbonate, polyether prepolymer; a degrading catalyst being comprised of at least one of a group consisting of a metal oxide or a base additive; and a cross-linking agent so as to reach fracture between 8 hours and 3 days, display more than 60% weight change within 10 days, and the degradable polymeric composite sealing components maintain over 8000 psi pressure differential.

### BRIEF DESCRIPTION OF THE SEVERAL VIEWS OF THE DRAWINGS

FIGS. 1a-1e are sets of photos illustrating dissolution process of embodiments of degradable polymeric materials according to the present invention.

FIG. 1a shows dissolution process of a prior art commercial dissolvable rubber in 0.3% KCl at 90 degrees Celsius.

FIG. 1b shows dissolution process of an embodiment of the present invention CNPC-MTDR-1 in 0.3% KCl at 80 degrees Celsius.

FIG. 1c shows dissolution process of an embodiment of the present invention CNPC-MTDR-1 in 0.3% KCl at 80 degrees Celsius.

FIG. 1d shows dissolution process of an embodiment of the present invention CNPC-HTDR-1 in 0.3% KCl at 95 degrees Celsius.

FIG. 1e shows dissolution process of an embodiment of the present invention CNPC-LTDR-1 in 0.3% KCl at 50 degrees Celsius.

FIG. 2 is a graph illustration of weight change vs. time, showing dissolution rates of the prior art and an embodiment of the degradable polymeric material according to the present invention (CNPC-MTDR-1) in 0.3% KCl at 80 degrees Celsius.

FIG. 3 is a graph illustration of stress and strain, showing the prior art and an embodiment of the degradable polymeric material according to the present invention (CNPC-MTDR-1) at 100 degrees Celsius.

FIG. 4 is a graph illustration of weight change vs. time, showing dissolution rates of the prior art and an embodiment of the degradable polymeric material according to the present invention (CNPC-HTDR-1) in 0.3% KCl at 95 degrees Celsius.

FIG. 5 is a graph illustration of pressure and temperature against time, showing pressure holding of an embodiment of the degradable polymeric material sealing component according to the present invention (CNPC-MTDR-1) in water at 100 degrees Celsius.

### DETAILED DESCRIPTION OF THE INVENTION

The term “about” means plus or minus 20%, more preferably plus or minus 10%, even more preferably plus or minus 5%, most preferably plus or minus 2%.

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All percentages for weights expressed herein are by weight of the total product unless specifically stated otherwise.

The technical means, creative features, objectives, and effects of the patent application may be easy to understand, the following embodiments will further illustrate the patent application. However, the following embodiments are only the preferred embodiments of the utility patent application, not all of them. Based on the examples in the implementation manners, other examples obtained by those skilled in the art without creative work shall fall within the protection scope of the present invention. The experimental methods in the following examples are conventional methods unless otherwise specified. The materials and reagents used in the following examples can be obtained from commercial sources unless otherwise specified.

Polyurethane elastomers are frequently used in applications that require a combination of physical, chemical and dynamic properties such as good abrasion resistance, tear strength and low hysteresis. Prepolymers from toluene diisocyanate (TDI) and a variety of polyols may be cured with aromatic diamine curatives such as methylene bis (orthochloroaniline) (MBCA) available as Vibracure A133, from the Chemtura Corporation, to yield such elastomers.

The isocyanate terminated urethane prepolymers are known in the art and can be formed by first reacting a polyol with a molar excess of an organic diisocyanate monomer to form a prepolymer having terminal isocyanate groups, and then optionally removing the residual excess diisocyanate monomer.

The prepolymer is made by reacting an excess of a polyisocyanate with a polyol that has a low glass transition temperature. It is normally a liquid material that is subsequently cured to form the final product. The prepolymer cures through reaction with a curing agent that has two or more isocyanate-reactive groups. For some applications, the curing agent is water, which may be atmospheric moisture.

The polyol most commonly used to make the prepolymer is a polyether. Polyether polyols have the advantage of being widely available and inexpensive; having good resistance to hydrolysis; and good elasticity. Polyester polyols are an alternative to the polyethers.

Polyurethanes made using polyester polyols tend to have greater mechanical strength and abrasion resistance, but these advantages are offset by poor resistance to hydrolysis and high prepolymer viscosities. An excellent combination of properties can be obtained using a polycarbonate as the polyol, but polycarbonate polyols are too expensive to be used economically in most applications. A preferred solution would be to obtain the mechanical performance obtained with polyester and polycarbonate polyols using a polyether polyol instead. Such a solution would take advantage of the lower costs and excellent hydrolytic stability provided by the polyethers.

This invention in one aspect is an isocyanate terminated prepolymer prepared by reacting an excess of at least one organic polyisocyanate having an isocyanate equivalent weight of up to 350 with a polyol mixture, the polyol mixture containing at least 50 weight percent, based on the weight of the polyol mixture of at least one polymer of propylene oxide having a hydroxyl equivalent weight of 500 to 3000 and a nominal hydroxyl functionality of at least 1.8, and 5 to 50 weight percent, based on the weight of the polyol mixture, of at least one bisphenol compound having a hydroxyl equivalent weight of up to 150, wherein the isocyanate terminated polyurethane prepolymer has an isocyanate content of 2 to 10% by weight.

The invention is also a polyurethane or polyurethaneurea produced by curing the isocyanate terminated prepolymer of the invention by reacting the isocyanate-terminated prepolymer with a curing agent.

It has been found that polyurethanes and polyurethane-polyesters, polycarbonate, polyether-prepolymer of the invention have unexpectedly good mechanical properties, particularly high tensile strength, tensile modulus and tear strength, compared to polyurethanes made by curing a like prepolymer made without the bisphenol compound. In addition, the polyurethanes exhibit other advantages of polyether based polyurethanes such as low cost, low viscosity and good hydrolytic stability.

The prepolymer is made in a reaction of one or more organic polyisocyanates with a polyol mixture. Each organic polyisocyanate has at least two isocyanate groups per molecule and an isocyanate equivalent weight of up to 350, such a 80 to 250, 80 to 200, or 80 to 180. If a mixture of such polyisocyanate compounds is present, the mixture may have, for example, an average of 2 to 4 or 2.3 to 3. 5 isocyanate groups per molecule. Among such polyisocyanate compounds are aromatic polyisocyanates such as m-phenylene diisocyanate, toluene-2, 4-diisocyanate, toluene-2, 6-diisocyanate, naphthylene-1, 5-diisocyanate, methoxyphenyl-2, 4-diisocyanate, diphenylmethane-4, 4′-diisocyanate, diphenylmethane-2, 4′-diisocyanate, 4, 4′-biphenylene diisocyanate, 3, 3′-dimethoxy-4, 4′-biphenyl diisocyanate, 3, 3′-dimethyl-4-4′-biphenyl diisocyanate, 3, 3′-dimethyldiphenyl methane-4, 4′-diisocyanate, 4, 4′, 4″-triphenyl methane triisocyanate, polymethylene polyphenylisocyanate (PMDI), toluene-2, 4, 6-triisocyanate and 4, 4′-dimethyldiphenylmethane2, 2′, 5, 5′-tetraisocyanate. Modified aromatic polyisocyanates that contain urethane, urea, biuret, carbodiimide, uretoneimine, allophanate or other groups formed by reaction of an isocyanate group are also useful. A preferred aromatic polyisocyanate is MDI or PMDI (or a mixture thereof that is commonly referred to as “polymeric MDI”), and socalled “liquid MDI” products that are mixtures of MDI and MDI derivatives that have biuret, carbodiimide, uretoneimine and/or allophanate linkages.

Further useful polyisocyanate compounds having an isocyanate equivalent weight of up to 350 include one or more aliphatic polyisocyanates. Examples of these include cyclohexane diisocyanate, 1, 3-and/or 1, 4-bis (isocyanatomethyl) cyclohexane, 1-methyl-cyclohexane-2, 4-diisocyanate, 1-methyl-cyclohexane-2, 6 diisocyanate, methylene dicyclohexane diisocyanate, isophorone diisocyanate and hexamethylene diisocyanate, any of which may be modified to contain urethane, urea, biuret, carbodiimide, uretoneimine, allophonate or other groups formed by reaction of an isocyanate group.

The mixture of polyols includes at least 50 weight percent, based on the weight of the polyol mixture, of at least one polymer of propylene oxide having a hydroxyl equivalent weight of 500 to 3000 and an average nominal functionality of at least 1.8. The equivalent weight may be at least 700 or at least 900, and may be up to 2500, up to 2000, up to 1750, up to 1500 or up to 1200.

The polymer mixture contains 5 to 50 weight percent, based on the weight of the polyol mixture, of at least one bisphenol compound having a hydroxyl equivalent weight of up to 150. The bisphenol compound may include one or more of resorcinol, catechol, hydroquinone, biphenol, bisphenol A (2, 2-bis (4-hydroxyphenyl) propane), bisphenol AP (1, 1-bis (4-hydroxylphenyl)-1-phenyl ethane), bisphenol AF (2, 2-bis (4-hydroxyphenyl) hexafluoropropane), bisphenol B (2, 2-bis (4-hydroxyphenyl) butane), bisphenol C (2, 2-Bis (3-methyl-4-hydroxyphenyl) propane), bisphenol E (1, 1-bis (4-hydroxyphenyl) ethane), bisphenol F (bis (4-hydroxyphenyl) methane), bisphenol S (bis (4-hydroxyphenyl) sulfone), bis (4-hydroxyphenyl) ether and tetramethylbiphenol.

In some embodiments, the bisphenol compound(s) constitute at least 9%, at least 12%, at least 15% or at least 20% of the weight of the polyol mixture and, in some embodiments, the bisphenol compounds constitute up to 40% or up to 30% of the weight of the polyol mixture.

Such additional polyols, if present at all, preferably are present in amounts no greater than 5%, especially no greater than 3% of the total weight of the polyol mixture. They may be absent so that the polymer(s) of propylene oxide and bisphenol compound constitute 100% of the weight of the polyol mixture.

The polyol mixture is reacted with an excess of the polyisocyanate(s) to produce the prepolymer. At least one mole of the polyisocyanate(s) is reacted per equivalent of hydroxyl groups in the polyol mixture. A greater excess can be used.

The prepolymer forming reaction can be performed under vacuum or in an inert atmosphere such as nitrogen, preferably with the exclusion water, at an elevated temperature and in the presence of a urethane catalyst such as a tertiary amine, tin, zinc or other metallic catalyst. The reaction is generally continued until the hydroxyl groups have been consumed, as indicated by a constant isocyanate content in the reaction mixture.

The resulting prepolymer may have an isocyanate content of, for example, at least 2 weight percent, at least 3 weight percent or at least 4 weight percent and up to 10 weight percent, up to 8 weight percent or up to 7 weight percent. Isocyanate content is conveniently determined using well-known titration methods.

The resulting prepolymer may have a number average isocyanate functionality of at least 1.8 and up to 10, preferably up to 8, up to 7 or up to 6, isocyanate groups per molecule.

For purposes of this invention, the “prepolymer” includes reaction products of the polyol mixture with the polyisocyanate, plus any unreacted starting polyisocyanate that may be present at the end of the reaction with the polyol mixture.

The prepolymer is useful for making a variety of polyurethane and/or polyurea products. These include, for example, coatings, adhesives, sealants and elastomers, as well as flexible foams. In general, polyurethane products are made by curing the prepolymer with one or more hydroxyl containing curing agents. Polyurethaneurea products are made by curing the prepolymer with a curing agent that includes water and/or a primary or secondary amine curing agent.

Hydroxyl curing agents include a wide range of polyols. The polyol curing agents can have hydroxyl equivalent weights of, for example, 30 to 3000 or more. They may contain 2 to 16 or more hydroxyl groups per molecule. Examples of polyol curing agents include polyether polyols, polyester polyols, polyalkylene carbonate polyols, hydroxyl-terminated diene rubbers, polyvinyl alcohols. In some embodiments, at least a portion of the hydroxyl curing agent has a hydroxyl equivalent weight of less than 175. In such a case, chain extenders and crosslinkers are useful components of the hydroxyl curing agent, and may even constitute the entirety of the hydroxyl curing agent.

Examples of useful hydroxyl-containing chain extenders include, for example, 1, 2-ethane diol, 1, 2- or 1, 3-propane diol, 1, 4 butane diol, diethylene glycol, triethylene glycol, dipropylene glycol, tripropylene glycol, neopentyl glycol and alkoxylates of any of the foregoing having a hydroxyl equivalent weight of less than 175.

Examples of hydroxyl-containing crosslinkers include glycerin, trimethylolpropane, trimethylolethane, erythritol, pentaerythritol, diethanolamine and alkoxylates of any of the foregoing having a hydroxyl equivalent weight of less than 175.

Similarly, amine curing agents can have an equivalent weight per primary and/or secondary amino group of 30 to 3000 or more and may contain 2 to 16 or more primary and/or secondary amino groups. The amino groups may be bonded directly to an aliphatic (including cycloaliphatic) or aromatic carbon atom. Aminated polyethers are examples of useful amine curing agents. In some embodiments the amine curing agent has an equivalent weight per primary and/or secondary amino group of less than 175. Examples of such low equivalent weight amine curing a gents include, for example, aliphatic polyamines such as ethylene diamine, piperazine, diethylene triamine, triethylene tetraamine, tetraethylenepentaaminepiperazine, N-(2-aminoethyl) piperazine, N, N′-bis (2-aminoethyl) piperazine, cyclohexane diamine (including any one or more of the 1, 2-, 1, 3- and 1, 4-isomers), bis (aminomethyl) cyclohexane (including any one or more of the 1, 2-, 1, 3- and 1, 4-isomers) and bis (2-aminoethyl) cyclohexane, and aromatic polyamines such as toluene diamine, diethyltoluenediamine, methylenediphenyldiamine phenylene diamine, bis (aminomethyl) benzene and aromatic amine-terminated polyethers.

Amino alcohols such as ethanolamine and diethanolamine are also useful curing agents.

In some embodiments, the invention is a sealant or adhesive comprising the prepolymer of the invention. Such a sealant or adhesive may be a one-component type in which all the ingredients of the composition are blended and packaged together, except for water when the sealant or adhesive is a moisture-curing type (i.e., one that cures at least partially via a water/isocyanate reaction). If a curing agent is present in such a one-component sealant or adhesive, it is preferably a blocked, encapsulated or otherwise latent type that requires an elevated temperature of at least 50° C. to become activated and reactive toward the isocyanate groups of the prepolymer.

A one-component sealant or adhesive may consist entirely of the prepolymer (and curing agent if not moisture curable). The sealant or adhesive may contain other ingredients such as, for example, one or more curing catalysts; one or more viscosity and/or rheology modifiers such as thickeners, diluents and thixotropic agents; particulate fillers and/or pigments such as carbon black, ochre, titanium dioxide, clay, calcium carbonate, calcium oxide, iron oxide and the like; adhesion promoters; coupling agents; dyes or other colorants; preservatives; antioxidants and surfactants.

An adhesive or sealant of the invention can be used in the same manner as conventional polyurethane or polyurethaneurea sealants or adhesives. No special handling or curing conditions are needed. Thus, for example, an adhesive of the invention is used to bond two substrates in a process that includes forming a layer of the adhesive of the invention at a bondline between the two substrates and curing the adhesive at the bondline to form a cured adhesive layer bonded to the two substrates at the bondline. If the adhesive is moisture curing, the adhesive layer is exposed to a source of water. The water can be supplied as liquid water and/or in the form of atmospheric moisture.

The prepolymer can be used as a component of a polyurethane or polyurethane-urea coating composition. In such a coating composition, the prepolymer may be dispersed into an aqueous phase that includes water and preferably one or more external surfactants, and then reacted with a chain extender, preferably a diamine chain extender, to form polyurethane particles dispersed in the aqueous phase. The coating composition may further contain other useful ingredients such as described above with respect to sealants and adhesives.

The prepolymer of the invention is also useful to make polyurethane or polyurethane-urea elastomers. Such elastomers are conveniently made in a molding process in which the prepolymer and a curing agent are combined and cured in an open or closed mold. The reaction mixture may be frothed by whipping in air, and/or can be foamed slightly, to produce a microcellular structure. As before, various optional ingredients may be included in the reaction mixture as desired.

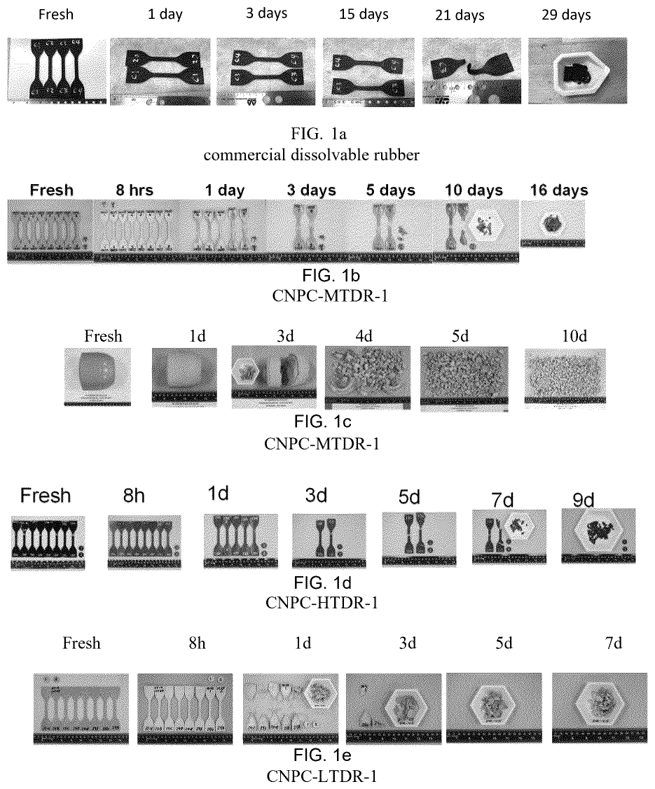

FIGS. 1 (a-e) to 5 show the chemical composition of the present invention as a degradable polymeric material compatible for the conditions associated with downhole operations, such as hydraulic fracturing operations. When the chemical composition is formed in a component of a downhole tool, the component must have the same functionality as the conventional non-dissolving component. The component must be sufficiently strong to seal and hold a pressure differential as assembled in the downhole tool. The component must also properly dissolve in a wellbore fluid, such as a potassium chloride brine, after the downhole operation is completed. The chemical composition must not immediately dissolve too quickly in order to perform the downhole operation, while also dissolve quickly when the downhole operation is completed.

The chemical composition of the present invention is a degradable or dissolvable polymeric material being comprised of an isocyanate terminated polyester, polycarbonate, or polyether prepolymer, a catalyst additive, and a cross-linking agent. The structure of the isocyanate terminated polyester prepolymer can be shown as below.

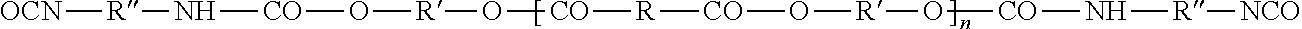

wherein R is an aryl group or alkyl group, wherein R′ is an aryl group or alkyl group, wherein R″ is an aryl group or alkyl group, and wherein n is a number of prepolymer units repeated corresponding to length of said main chain.

The isocyanate can be comprised of a low free isocyanate toluene diisocyanate (TDI), which is helpful to achieve narrow molecular distribution, virtual crosslinking, and more defined hard-phase and soft phase separation to achieve better mechanical properties.

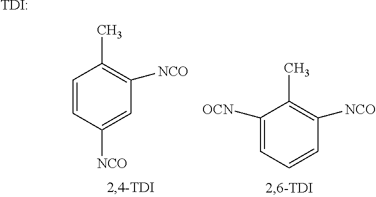

The isocyanate could also be, but not limited to methylene diphenyl diisocyanate (MDI), para-phenyl diisocyanate (pPDI), hexamethylene isocyanate (HDI) etc.

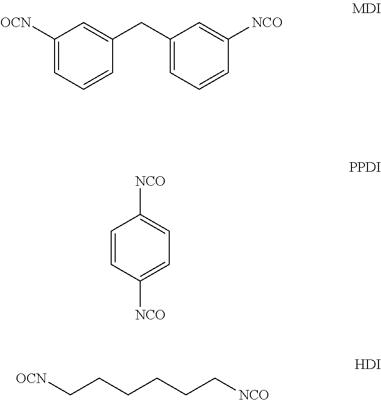

The cross-linking agent or cross linker can be diamine 4, 4′ methylene-bis-(o-chloroaniline), dimethyl thio-toluene diamine, diols, such as butanediol, polycarbonate polyols, polyester glycol, or triols.

4, 4′ methylene-bis-(o-chloroaniline):

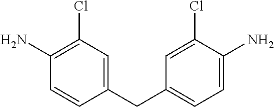 [SMILES: Nc1ccc(Cc2ccc(N)c(Cl)c2)cc1Cl]

Dimethyl thio-toluene diamine:

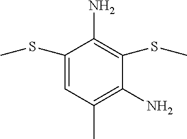

### Catalysts to Help Degrade the Composite

As discussed previously, a solid base including but not limited to Ca(OH)₂, CaO, Mg(OH)₂, KOH, NaOH, etc. Without catalyst, even the degradable polymer composite takes long time be hydrolyzed. The catalyst additive is comprised of a metal oxide, a base additive or both. The metal oxide can be sodium oxide, potassium oxide, calcium oxide, or magnesium oxide. The base additive can be a metal hydroxide or a Lewis base, and the metal hydroxide can be sodium hydroxide, potassium hydroxide, calcium hydroxide, or magnesium hydroxide.

In some embodiments, a catalyst may be present in the polymer composition in an amount ranging from about 1 weight percent to about 40 weight percent. In other embodiments, the catalyst may be present in an amount ranging from about 2 weight percent to about 30 weight percent; from about 5 weight percent to about 25 weight percent in other embodiments; and from about 8 to about 20 weight percent in yet other embodiments, where the above ranges are based on the total weight of the polyurethane resin mixture with the catalyst, and the cycloaliphatic anhydride cross-linker.

### Dissolving Property of Disclosed Degradable Polymer

Solid base catalyst is crucial to hydrolysis of degradable polymers. Test shows that solid base can catalyze the hydrolysis process. Solid base may be better because the material degrades in the form of surface-etching process, which does not deteriorate mechanical properties of whole material during degradation process.

A load of catalyst may also be critical in degradable polymers. Take Ca(OH)₂ as an example, ratio between degradable polymers and Ca(OH)₂ may be 1:10 to 10:1, more specifically the ratio being controlled between about 1:0.8 to about 1:1.2, for example. A ratio out of this range may have various issues, either failing to degrade or causing problems in processing.

The strength of the chemical composition of the present invention can be further enhanced by incorporating fillers, such as carbon blacks, silica, nanographene, nanoclays, nanofibers, nanotubes, etc.

TABLE 1
Description of embodiments of the invention

| Formulation | Hardness | | Catalyst |
|---|---|---|---|
| Name | (Shore A) | Polymer Desciption | Additive |
| CNPC-MTDR-1 | 93 | Medium temperature dissolvable | metal oxide |
| | | rubber based on Polyester- | |
| | | polurethane coopolymer | |
| CNPC-LTDR-1 | 85 | Low temperature dissolvable | metal oxide |
| | | rubber based on Polyester- | with base |
| | | polurethane coopolymer | additive |
| CNPC-HTDR-1 | 95 | High temperature dissolvable | Base |
| | | rubber based on Polyester- | additive |
| | | polurethane coopolymer | |

One method to make the dissolvable polymer is to mix the proper ratio of isocyanate terminated polyester prepolymer, the catalyst additive, and the cross-linking agent. There can also be reinforcing agents, pigments, surfactants, etc. The isocyanate terminated polyester, polycarbonate, or polyether prepolymer and cross-linking agent were vacuumed before mixing. The mixing is achieved with centrifuge mixing or other mixing method either under vacuum or not. The mixer was then casted in a mold and then performed casting molding or rotational molding. The cured polymers were then demolded as a component and possibly post-cured. The mixture could be also compression molded in the mold until the mixture was fully cured.

Embodiments of the method for formation of a degradable polymeric material include vacuuming the isocyanate terminated prepolymer of the chemical composition of the present invention, vacuuming the cross-linking agent, mixing the isocyanate terminated prepolymer, the catalyst additive, and the cross-linking agent so as to form a mixture, and molding the mixture so as to form a cured polymer as a component.

The step of mixing the isocyanate terminated prepolymer, the cross-linking agent, and the catalyst is by centrifuge and can be under vacuum. Additionally, the step of mixing the isocyanate terminated prepolymer, the cross-linking agent, and the catalyst further comprises adding a filler. The filler is selected from a group consisting of carbon blacks, silica, nanographene, nanoclays, nanofibers, and nanotubes. The step of molding the mixture comprises casting the mixture into a mold and curing the mixture or casting the mixture into a mold, rotating the mold, and curing the mixture or casting the mixture into a mold, compressing the mixture in the mold, and curing the mixture.

FIG. 1a shows the dissolution process of a prior art rubber material commercial dissolvable rubber in 0.3% KCl at 90 degrees Celsius. The material is intact after 15 days, and the evidence of fracture is at 21 days. This time to dissolve can be controlled, while still being suitable for use as a downhole tool component. The present invention can reach fracture between 8 hours and 3 days, display more than 60% weight change within 10 days, and the degradable polymeric composite sealing components maintain over 8000 psi pressure differential over 24 hours. While temperature affects the time to dissolve, the material composition must be able to react properly. The salinity can also be zero, as in water. The concern of the present invention is not simply dissolving within a particular time window. The material composition must also maintain modulus and elongation so that the material is functional, while dissolving depending on temperature and not affected by salinity.

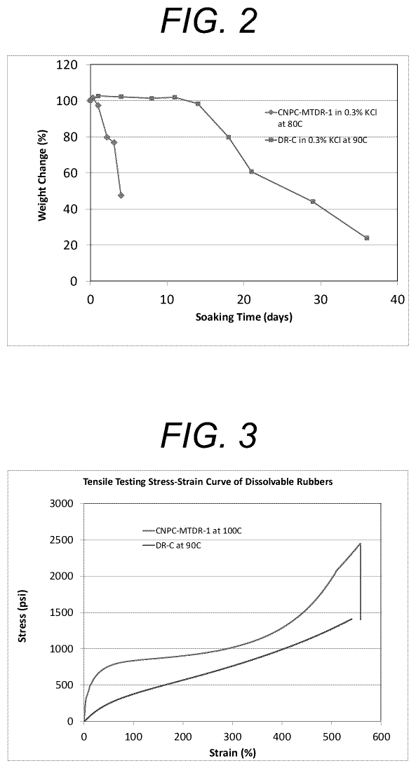

One embodiment of the present invention is CNPC-MTDR-1 with the catalyst additive as a metal oxide. FIG. 1b shows the dissolution process of an embodiment of the present invention in 0.3% KCl at 80 degrees Celsius. FIG. 1c also shows the dissolution process of an embodiment of the present invention CNPC-MTDR-1 in 0.3% KCl at 80 degrees Celsius. In this embodiment, the fracture is between 1 day and 3 days in 0.3% KCl at 80 degrees Celsius. CNPC-MTDR-1 is intact after 1 day and can be functional in a downhole tool component. FIG. 2 further shows that the present invention displays more than 60% weight change within 10 days in 0.3% KCl at 80 degrees Celsius. FIG. 3 shows a stress-strain curve increase faster over 1000 psi and over 300% strain than less than 1000 psi and less than 300% strain. Again, the innovation is the identified balance between being able to dissolve, while still being functional (high modulus, high elongation) in terms of strength for a material of a downhole tool component.

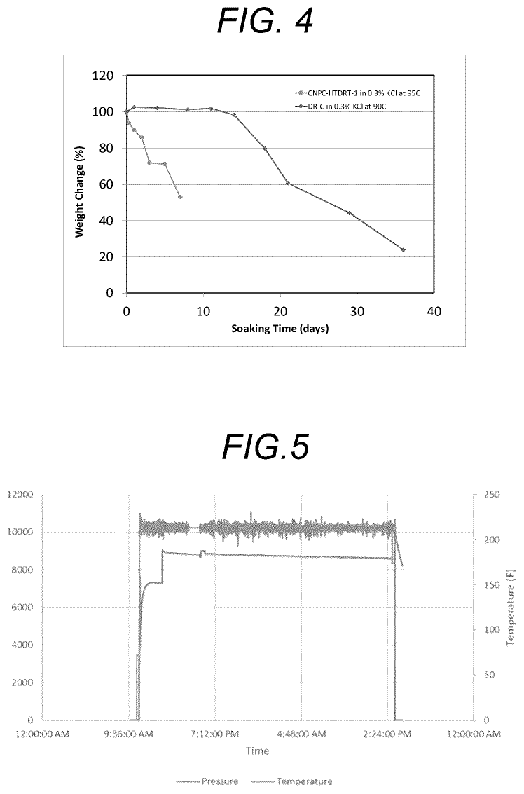

Another embodiment of the present invention is CNPC-HTDR-1 with the catalyst additive as a base additive. The base additive is a metal hydroxide. FIG. 1d shows the dissolution process of an embodiment of the present invention CNPC-HTDR-1 in 0.3% KCl at 95 degrees Celsius. In this embodiment, the fracture is between 1 day and 3 days in 0.3% KCl at 95 degrees Celsius. CNPC-HTDR-1 is also intact after 1 day and can be functional in a downhole tool component. FIG. 4 further shows that the present invention displays more than 60% weight change within 10 days in 0.3% KCl at 95 degrees Celsius. While dissolving faster than the prior art dissolvable rubber of FIG. 1a, similar to the embodiment of CNPC-MTDR-1, the innovation is the identified balance between being able to dissolve, while still being functional (high modulus, high elongation) in terms of strength for a material of a downhole tool component.

Still another embodiment of the present invention is CNPC-LTDR-1 with the catalyst additive as both the metal oxide and a base additive. The base additive is still a metal hydroxide. FIG. 1e shows the dissolution process of an embodiment of the present invention CNPC-LTDR-1 in 0.3% KCl at 50 degrees l at 50 degrees Celsius. CNPC-LTDR-1 is a fast dissolvable material but can still be functional in a downhole tool component. FIG. 5 further shows that the present invention of the degradable polymeric composite sealing components maintains over 8000 psi pressure differential over 24 hours in water at 100 degrees Celsius. While dissolving fast, the present invention can still maintain a seal as the material is dissolving. The embodiment identifies balance between being able to dissolve, while still being functional (high modulus, high elongation) in terms of maintaining pressure for a sealing component of a downhole tool. Thus, the embodiments of the chemical composition of the present invention can be used as the sealing component of a dissolvable frac plugs, bridge plugs, packers, etc.

The downhole tool can be an assembly of components, and one of those components can be made of an embodiment of the chemical composition of the present invention. The method comprising the steps of: forming the chemical composition according to present invention into a component, installing the component in an assembly, such as a downhole tool, dissolving the component in aqueous solution at 80 degrees Celsius into a degraded component, and collapsing the assembly so as to remove the assembly and the degraded component.

The invention provides a high modulus, high elongation degradable polymeric material or dissolvable rubber material composition, and the method of manufacturing the composition. The invention also discloses methods to use the chemical composition to make a component with a dissolving rate that can be controlled by cross-linking agents and catalyst additives.

The present invention provides a high strength, high modulus, flexible water dissolvable rubber material made of a polyester, polycarbonate, polyether polyurethane copolymer. The copolymer can be a low free isocyanate TDI terminated polyester polymer crosslinked with various cross-linking agents. The cross-linking agent or crosslinker can include diamines, diols, triols, etc. Particular cross-linking agents include diamines, such as 4, 4′ methylene-bis-(o-chloroaniline), and dimethyl thio-toluene diamine.

Embodiments of the invention include filler to increase the strength of the embodiments of the chemical composition of the present invention. Fillers can be carbon blacks, silica, nanographene, nanoclay, nanofibers, nanotubes, etc.

The embodiments of the chemical composition of the present invention as dissolvable rubbers have the applications in oil and gas downhole completion, drilling, measurement tools, such as dissolvable plug, packers, isolation valves, etc. The composition can also have a modulus and elongation sufficient to hold high pressure differentials of a sealing component of a downhole tool during downhole operations, while remaining dissolvable.

The foregoing disclosure and description of the invention is illustrative and explanatory thereof. Various changes in the details of the illustrated structures, construction and method can be made without departing from the true spirit of the invention.

We claim:

1. A degradable polymeric composite comprising a reaction product of:
an isocyanate;
polyol,
a degrading catalyst comprising at least one of a group consisting of a metal oxide or a base additive; and
a cross-linking agent so as to reach fracture between about 8 hours and about 3 days, display more than 60% weight change within about 10 days, depending on temperature, and the degradable polymeric composite sealing components maintain over about 8000 psi pressure differential.

2. The degradable polymeric composite of claim 1, wherein said isocyanate is selected from a group consisting of: 2, 4-toluene di-isocyanate, 2, 6 toluene di-isocyanate, methylene diphenyl diisocyanate (MDI), para-phenyl diisocyanate (pPDI)), and hexamethylene isocyanate (HDI).

3. The degradable polymeric composite of claim 1, wherein the degrading catalyst comprises at least one of solid base.

4. The degradable polymeric composite of claim 1, wherein said metal oxide is selected from a group consisting of: sodium oxide, potassium oxide, calcium oxide, and magnesium oxide.

5. The degradable polymeric composite of claim 1, wherein the base additive is at least one of a metal hydroxide or a Lewis base. PATENT

6. The degradable polymeric composite of claim 5, wherein the metal hydroxide is selected from a group consisting of: sodium hydroxide, potassium hydroxide, calcium hydroxide, and magnesium hydroxide.

7. The degradable polymeric composite of claim 1, wherein the cross-linking agent is at least one of diamines, diols, or triols.

8. A process for forming a degradable polymer composition, the process comprising:
admixing an isocyanate and a polyol to form a mixture;
adding a degrading catalyst to the mixture; and
mixing a cross-linking agent so as to reach fracture between 8 hours and 3 days, display more than about 60% weight change within about 10 days, depending on temperature, and the degradable polymeric composite sealing components maintain over about 8000 psi pressure differential.

9. The process of claim 8, wherein the cross-linking agent is at least one of diamines, diols, or triols.

10. The process of claim 8, wherein said isocyanate is selected from a group consisting of: 2, 4-toluene di-isocyanate, 2, 6 toluene di-isocyanate, methylene diphenyl diisocyanate (MDI), para-phenyl diisocyanate (pPDI), and hexamethylene isocyanate (HDI).

11. The process of claim 8, wherein the degrading catalyst comprises at least one of solid base.

12. The process of claim 11, wherein the solid base is at least one of metal oxide or metal hydroxide.

13. The process of claim 12, wherein the metal hydroxide is selected from a group consisting of: sodium hydroxide, potassium hydroxide, calcium hydroxide, and magnesium hydroxide.

14. The process of claim 8, where in the cross-linking agent is at least one of diamines, diols, or triols.

15. A degradable polymer composite, comprising a reaction product of:
an isocyanate terminated polyester, polycarbonate, polyether prepolymer;
a degrading catalyst being comprised of at least one of a group consisting of a metal oxide or a base additive; and
a cross-linking agent so as to reach fracture between about 8 hours and about 3 days, display more than 60% weight change within about 10 days, and the degradable polymeric composite sealing components maintain over about 8000 psi pressure differential.

16. The degradable polymer composite of claim 15, where in the cross-linking agent is at least one of diamines, diols, or triols.

17. The degradable polymer composite of claim 15, wherein said metal oxide is selected from a group consisting of: sodium oxide, potassium oxide, PATENT calcium oxide, and magnesium oxide.

18. The degradable polymer composite of claim 16, wherein the base additive is at least one of a metal hydroxide or a Lewis base, wherein the metal hydroxide is selected from a group consisting of: sodium hydroxide, potassium hydroxide, calcium hydroxide, and magnesium hydroxide.

19. A method for formation of a degradable polymeric material, the method comprising the steps of:
vacuuming said isocyanate terminated polyester, polycarbonate, or polyether prepolymer of claim 15;
vacuuming said cross-linking agent;
mixing said isocyanate terminated prepolymer, said catalyst additive, and said cross-linking agent so as to form a mixture; and
molding said mixture so as to form a cured polymer as a component.

20. A method for removal, the method comprising the steps of:
forming a chemical composition according to claim 15 into a component;
installing said component in an assembly;
dissolving said component in an aqueous solution into small particles; and
collapsing said assembly so as to remove said assembly and said degraded component.
